(19) United States
(12) Patent Application Publication
(10) Pub. No.: US 2018/0217550 A1
(43) Pub. Date: Aug. 2, 2018

(54) PAPER FEEDING DEVICE AND IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Koichi Akiyama, Yokohama Kanagawa (JP)

(21) Appl. No.: 15/464,656

(22) Filed: Mar. 21, 2017

(30) Foreign Application Priority Data
Feb. 2, 2017 (JP) 2017-017868

(51) Int. Cl. G03G 15/00; B65H 35/08

(52) U.S. Cl. CPC G03G 15/6523; G03G 15/652; B65H 2801/06; B65H 2301/44318; B65H 2301/51256; B65H 35/08

(57) ABSTRACT

A paper feeding device in an embodiment includes a roll-paper storing unit, a curl rectifying unit, and a cutting unit. The roll-paper storing unit is capable of storing roll paper. The curl rectifying unit is disposed on a downstream side of the roll-paper storing unit in a conveying direction of a sheet let out from the roll paper and rectifies a curl of the sheet. The cutting unit is disposed on the downstream side of the curl rectifying unit in the conveying direction and cuts the sheet.

### CROSS-REFERENCE TO RELATED APPLICATION

This application is based upon and claims the benefit of priority from Japanese Patent Application No. 2017-017868, filed Feb. 2, 2017, the entire contents of which are incorporated herein by reference.

### FIELD

Embodiments described herein relate generally to a paper feeding device and an image forming apparatus.

### BACKGROUND

An image forming apparatus forms an image on a sheet of a predetermined size. There is a demand for an image forming apparatus that can feed a high-quality sheet of any size and form an image on the sheet.

JP-A-6-48628 is an example of related art.

### DESCRIPTION OF THE DRAWINGS

FIG. 1 is a side sectional view showing a schematic configuration example of an image forming apparatus in an embodiment;

FIG. 2 is a side sectional view showing a schematic configuration example of a paper feeding device in the embodiment;

FIG. 3 is a side view showing a curl rectifying unit;

FIG. 4 is a side view showing a first modification of the curl rectifying unit;

FIG. 5 is a side view showing a second modification of the curl rectifying unit;

FIG. 6 is a perspective view of a rotary cutter; and

FIG. 7 is a perspective view of a rotary blade and a rotary-blade supporting member.

### DETAILED DESCRIPTION

An object of embodiments described herein is to provide a paper feeding device and an image forming apparatus that can feed a high-quality sheet of any size and form an image on the sheet.

In general, according to one embodiment, a paper feeding device includes a roll-paper storing unit, a curl rectifying unit, and a cutting unit. The roll-paper storing unit is capable of storing roll paper. The curl rectifying unit is disposed on a downstream side of the roll-paper storing unit in a conveying direction of a sheet let out from the roll paper and rectifies a curl of the sheet. The cutting unit is disposed on the downstream side of the curl rectifying unit in the conveying direction and cuts the sheet.

A paper feeding device and an image forming apparatus in an embodiment are explained below with reference to the drawings. In this application, X, Y, and Z directions are defined as explained below. The Z direction is the vertical direction. The X direction and the Y direction are the horizontal direction. The Z direction is the up-down direction (the height direction) of the image forming apparatus. A +Z direction is the upward direction. The X direction is the front-back direction (the depth direction) of the image forming apparatus. A +X direction is the forward direction. The Y direction is the left-right direction (the width direction) of the image forming apparatus.

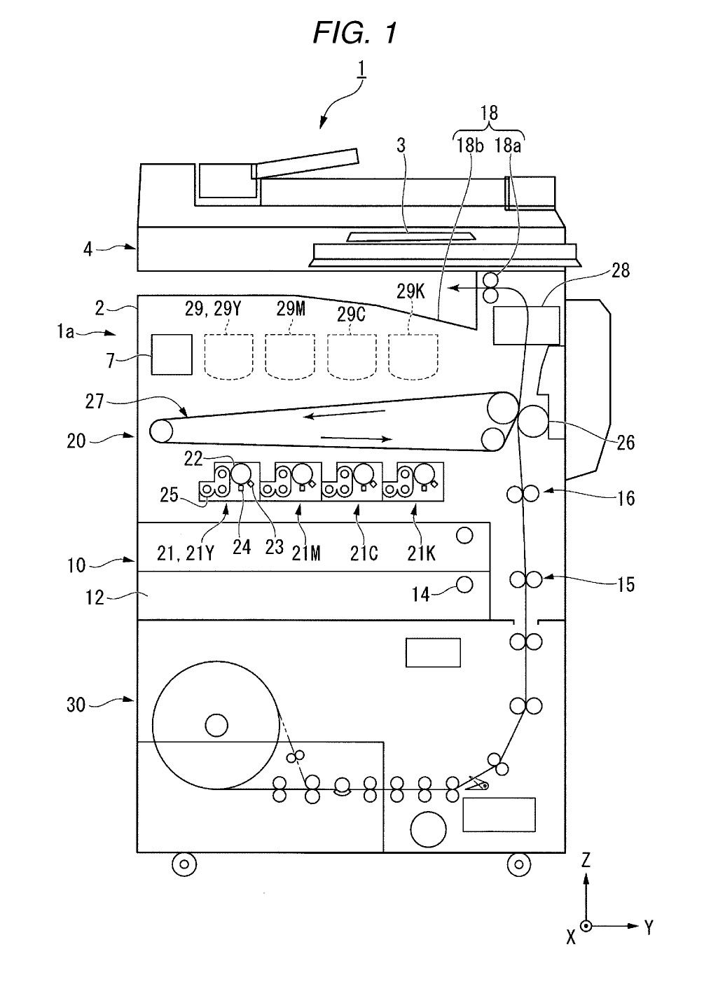

FIG. 1 is a side sectional view showing a schematic configuration example of an image forming apparatus 1 in the embodiment. For example, the image forming apparatus 1 is a multi function peripheral (MFP). The image forming apparatus 1 reads image information of a copying target object such as a sheet and generates digital data (an image file). The image forming apparatus 1 forms an image on the sheet using a recording agent on the basis of the digital data. A specific example of the recording agent is toner. The recording agent is one of a decolorable recording agent and a non-decolorable recording agent.

Toner used as the decolorable recording agent has a function of performing decoloring according to application of energy from the outside. The application of the energy from the outside means application of an external stimulus such as temperature, light having a specific wavelength, or pressure. The “decoloring” in this embodiment means making invisible an image formed in a color (including not only chromatic colors but also achromatic colors such as white and black) different from a base color of a sheet.

The configuration of the image forming apparatus 1 is explained.

As shown in FIG. 1, the image forming apparatus 1 includes an image forming apparatus main body 1a and a paper feeding device 30. The image forming apparatus main body 1a includes a housing 2, a display unit 3, a scanner unit 4, a paper feeding unit 10, a printer unit 20, a paper discharge unit 18, and a main-body control unit 7. The main-body control unit 7 controls the operations of the display unit 3, the scanner unit 4, the paper feeding unit 10, the printer unit 20, and the paper discharge unit 18.

The housing (a machine body or a case) 2 forms an outer shell of the image forming apparatus main body 1a.

The display unit 3 is disposed on the upper surface of the image forming apparatus main body 1a. The display unit 3 includes a touch panel. The display unit 3 displays various kinds of information concerning image formation.

The scanner unit 4 is disposed above the image forming apparatus main body 1a. The scanner unit 4 reads image information of a copying target object as contrast of light. The scanner unit 4 outputs the read image information to the printer unit 20.

The paper feeding unit 10 feeds and conveys a sheet of a regular size. The paper feeding unit 10 includes a paper feeding cassette 12, a pickup roller 14, a conveying roller 15, and a registration roller 16.

The paper feeding cassette 12 is disposed in a lower part of the image forming apparatus main body 1a. The paper feeding cassette 12 stores sheets of the regular size before image formation. The pickup roller 14 extracts the sheets from the paper feeding cassette 12 one by one. The pickup roller 14 feeds the sheet toward the conveying roller 15.

The conveying roller 15 conveys the sheet fed from the pickup roller 14 toward the registration roller 16. The conveying roller 15 conveys a sheet fed from the paper feeding device 30 explained below toward the registration roller 16. The registration roller 16 temporarily receives the leading end of the conveyed sheet and corrects a tilt of the sheet. The registration roller 16 feeds the sheet to the printer unit 20.

The printer unit 20 is disposed in the center of the image forming apparatus main body 1a. The printer unit 20 forms an image on the sheet with a developer such as toner on the basis of image information received from the scanner unit 4 or the outside. The printer unit 20 includes a toner-cartridge storing unit 29, an image forming unit 21, an intermediate transfer body 27, a secondary transfer roller 26, and a fixing device 28.

The toner-cartridge storing unit 29 stores toner cartridges in which toners of respective colors of yellow (29Y), magenta (29M), cyan (29C), and black (29K) are filled.

The image forming unit 21 forms images of the respective colors of yellow (21Y), magenta (21M), cyan (21C), and black (21K). The image forming unit 21 includes a photoconductive drum 22, a charger 23, an exposing device 24, and a developing device 25.

The photoconductive drum 22 is formed in a columnar shape. A photoconductive material is disposed on the outer circumferential surface of the photoconductive drum 22. The photoconductive material has a characteristic of retaining static electricity in a dark state and emitting the static electricity only in a portion irradiated with light. The photoconductive drum 22 rotates in a predetermined direction around the center axis.

The charger 23 charges the surface of the photoconductive drum 22 with the static electricity. For example, the charger 23 includes a plurality of needle electrodes. The plurality of needle electrodes are disposed side by side in a rotation axis direction of the photoconductive drum 22. The charger 23 charges the surface of the photoconductive drum 22 with the static electricity according to electric discharge from the plurality of needle electrodes.

The exposing device 24 forms an electrostatic latent image corresponding to the image information on the surface of the photoconductive drum 22. For example, the exposing device 24 includes a laser irradiating device. The laser irradiating device irradiates a laser beam on the surface of the rotating photoconductive drum 22 on the basis of the image information. On the surface of the photoconductive drum 22, a portion on which the laser beam is irradiated emits static electricity and the other portions retain the static electricity. Consequently, the exposing device 24 forms the electrostatic latent image corresponding to the image information on the surface of the photoconductive drum 22.

The developing device 25 supplies toner to the surface of the photoconductive drum 22 and develops the electrostatic latent image with the toner. The toner is supplied from the toner cartridge stored in the toner-cartridge storing unit 29 to the developing device 25. A two-component developer including toner and a carrier is stored in the inside of the developing device 25. The carrier passes the toner from the developing device 25 to the photoconductive drum 22. On the surface of the photoconductive drum 22, only the portion that emits the static electricity according to the exposure attracts the toner that is negatively charged. Consequently, the developing device 25 develops, with the toner, the electrostatic latent image on the surface of the photoconductive drum 22.

The intermediate transfer body 27 is an endless belt. The intermediate transfer body 27 is disposed along the image forming unit 21 that forms images of the respective colors. The outer surface of the intermediate transfer body 27 is disposed close to the photoconductive drum 22. A positive voltage is applied from the inner side of the intermediate transfer body 27. The negatively charged toner shifts from the photoconductive drum 22 to the intermediate transfer body 27. Consequently, a toner image on the photoconductive drum 22 is transferred onto the intermediate transfer body 27. Toner images of the respective colors are laid one on top of another on the intermediate transfer body 27.

The secondary transfer roller 26 is disposed side by side with the intermediate transfer body 27. The secondary transfer roller 26 presses a conveyed sheet against the intermediate transfer body 27. The secondary transfer roller 26 applies the positive voltage to the sheet from the rear side of the sheet. The negatively charged toner shifts from the intermediate transfer body 27 to the sheet. Consequently, the secondary transfer roller 26 transfers the toner image on the intermediate transfer body 27 onto the sheet.

The fixing device 28 fixes the toner image on the sheet. For example, the fixing device 28 includes a heating roller and a pressurizing roller. The sheet, onto which the toner image is transferred, passes a nip formed between the heating roller and the pressurizing roller. The heating roller heats the toner. The pressurizing roller pressurizes the toner toward the sheet. The toner changes a phase from powder to liquid and penetrates into fibers of the sheet. The toner is cooled to be solidified and is fixed on the sheet. Consequently, the fixing device 28 fixes the toner image on the sheet. In this way, an image is formed on the sheet.

The paper discharge unit 18 includes a paper discharge roller 18a and a paper discharge tray 18b. The paper discharge roller 18a discharges the sheet after the image formation to the paper discharge tray 18b. The sheet after the image formation is stacked on the paper discharge tray 18b. For example, the paper discharge tray 18b is disposed between the scanner unit 4 and the printer unit 20.

The paper feeding device 30 feeds a sheet to the image forming apparatus main body 1a. The paper feeding device 30 is disposed under the image forming apparatus main body 1a. The paper feeding device 30 have size equivalent to the size of the image forming apparatus main body 1a in plan view. The paper feeding device 30 is detachably attachable to the image forming apparatus main body 1a. The paper feeding device 30 can be used instead of a PFP (Paper Feed Pedestal) or an LCF (Large Capacity Feeder).

The configuration of the paper feeding device 30 is explained.

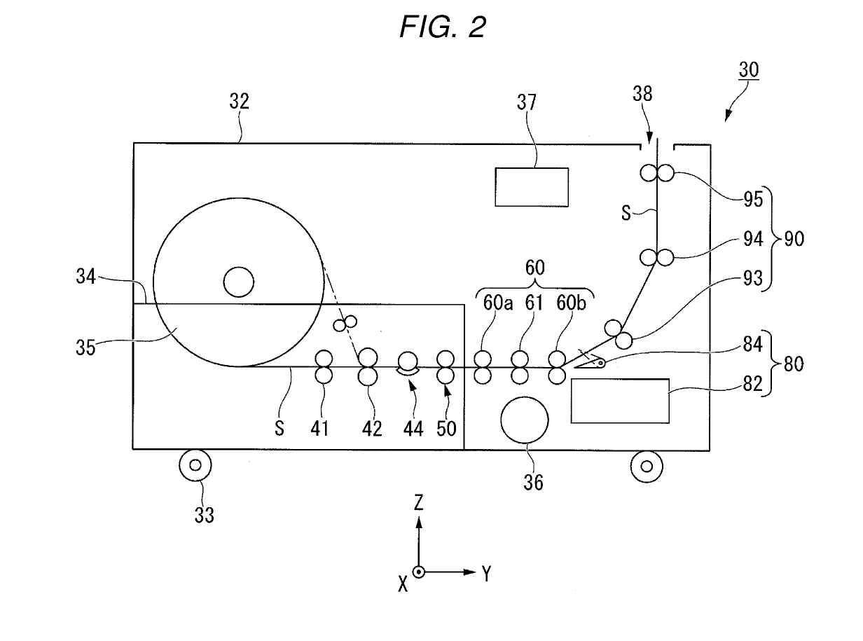

FIG. 2 is a side sectional view showing a schematic configuration example of the paper feeding device in the embodiment.

The paper feeding device 30 feeds a sheet S, which is let out from roll paper 35 and cut, to the image forming apparatus main body 1a. The roll paper 35 is obtained by rolling a sheet. The sheet is rolled with a printing surface directed to the inner side or the outer side. For example, the sheet S is plain paper or label paper. The label paper includes a label, adhesive glue, and a mount. The adhesive glue is disposed between the label and the mount.

The paper feeding device 30 includes a case 32 and a cassette 34. The case 32 forms an outer shell of the paper feeding device 30. The case 32 includes casters 33 under the case 32. The case 32 includes an outlet 38 for delivering the sheet S to the outside. The outlet 38 is formed on the upper surface of the case 32. The outlet 38 is disposed at a first end portion in the Y direction of the case 32. The cassette 34 is a roll-paper storing unit capable of storing the roll paper 35. The cassette 34 is disposed at a second end portion in the Y direction of the case 32. The cassette 34 and the outlet 38 are disposed at an interval in the Y direction. The cassette 34 can be drawn out in the horizontal direction from the case 32. The roll paper 35 is stored in the cassette 34 drawn out from the case 32.

The paper feeding device 30 includes a motor 36 and a control unit 37. The motor 36 drives to rotate various rollers explained below and conveys the sheet S let out from the roll paper 35. The control unit 37 controls the operations of the constituent members of the paper feeding device 30.

The paper feeding device 30 includes a guide roller 41, a paper feeding roller 42, a glue removing unit 44, a curl rectifying unit 50, a cutting unit 60, a sheet discarding unit 80, and an outlet unit 90 in this order along a conveying direction of the sheet S let out from the roll paper 35 (simply referred to as “conveying direction”).

The guide roller 41 guides the sheet S drawn out from the roll paper 35 to the paper feeding roller 42. The guide roller 41 is supported by the cassette 34 or the case 32.

The paper feeding roller 42 lets out the sheet S from the roll paper 35 and conveys the sheet S. The paper feeding roller 42 is supported by the cassette 34 or the case 32. The paper feeding roller 42 includes a driving roller and a driven roller. The driving roller and the driven roller are disposed across the sheet S. The driving roller is driven to rotate by the motor 36. The driven roller rotates according to the rotation of the driving roller.

If the sheet S is the label paper, the glue removing unit 44 removes the adhesive glue oozing around the label. The glue removing unit 44 is supported by the cassette 34 or the case 32. The glue removing unit 44 may be detachably attachable to the cassette 34 or the case 32. If the sheet S is other than the label paper, the glue removing unit 44 is detached from the cassette 34 or the case 32. The glue removing unit 44 prevents the adhesive glue from adhering to the members on the downstream side in the conveying direction. The glue removing unit 44 is disposed on the upstream side of the curl rectifying unit 50. Consequently, the glue removing unit 44 prevents the adhesive glue from adhering to the curl rectifying unit 50. The glue removing unit 44 prevents the adhesive glue from adhering to the constituent members of the image forming apparatus main body 1a. The glue removing unit 44 may be disposed on the downstream side of the curl rectifying unit 50.

The curl rectifying unit 50 is supported by the cassette 34 or the case 32. The curl rectifying unit 50 rectifies a curl of the sheet S let out from the roll paper 35. The curl of the sheet S causes a sheet jam in a conveying route of the sheet S. The curl rectifying unit 50 prevents a sheet jam on the downstream side of the curl rectifying unit 50. The curl rectifying unit 50 is disposed on the upstream side of the cutting unit 60. Consequently, the curl rectifying unit 50 prevents a sheet jam in the cutting unit 60. The curl rectifying unit 50 prevents a sheet jam in the image forming apparatus main body 1a.

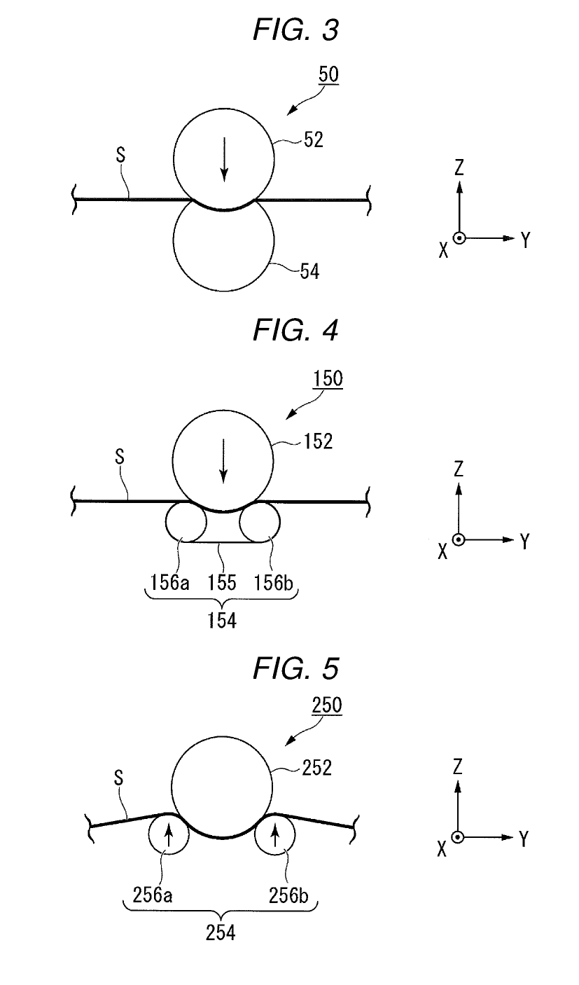

FIG. 3 is a side view showing the curl rectifying unit. The sheet S let out from the roll paper 35 curls in a specific direction. The curl rectifying unit 50 curves the sheet S in the opposite direction of the curl and rectifies the curl of the sheet S. The curl rectifying unit 50 includes a rigid body roller 52 and an elastic body roller 54. The outer circumferential surface of the rigid body roller 52 is formed of a hard material. The outer circumferential surface of the elastic body roller 54 is formed of a soft material. If the rigid body roller 52 is pressed against the elastic body roller 54, the outer circumferential surface of the elastic body roller 54 curves. The curl rectifying unit 50 holds the sheet S between the rigid body roller 52 and the elastic body roller 54 and curves the sheet S in the opposite direction of the curl.

FIG. 4 is a side view showing a first modification of the curl rectifying unit. A curl rectifying unit 150 in the first modification includes a rigid body roller 152 and a belt mechanism 154. The belt mechanism 154 includes an endless belt 155 and a pair of end rollers 156a and 156b. The endless belt 155 is laid over the pair of end rollers 156a and 156b. If the rigid body roller 152 is pressed against the endless belt 155 between the pair of end rollers 156a and 156b, the endless belt 155 curves. The curl rectifying unit 150 holds the sheet S between the rigid body roller 152 and the endless belt 155 and curves the sheet S in the opposite direction of the curl.

FIG. 5 is a side view showing a second modification of the curl rectifying unit. A curl rectifying unit 250 of the second modification includes a rigid body roller 252 and a sheet supporting mechanism 254. The sheet supporting mechanism 254 includes a pair of supporting rollers 256a and 256b. The pair of supporting rollers 256a and 256b is disposed apart from each other across the rigid body roller 252. If the sheet S is lifted by the pair of supporting rollers 256a and 256b, the sheet S is disposed along the outer circumferential surface of the rigid body roller 252. The curl rectifying unit 250 presses the sheet S against the outer circumferential surface of the rigid body roller 252 and curves the sheet S in the opposite direction of the curl.

The cutting unit 60 shown in FIG. 2 cuts the sheet S while conveying the sheet S. The cutting unit 60 is supported by the case 32. The cutting unit 60 includes a pair of cutting unit conveying rollers (first conveying rollers) 60a and 60b and a rotary cutter 61.

The pair of cutting unit conveying rollers 60a and 60b includes an upstream-side conveying roller 60a and a downstream-side conveying roller 60b. The upstream-side conveying roller 60a is disposed on the upstream side of the rotary cutter 61 in the conveying direction. The downstream-side conveying roller 60b is disposed on the downstream side of the rotary cutter 61 in the conveying direction. The cutting unit conveying rollers 60a and 60b include driving rollers and driven rollers. The driving rollers and the driven rollers are disposed across the sheet S. The driving rollers are driven to rotate by the motor 36. The driven rollers rotate according to the rotation of the driving rollers. The cutting unit conveying rollers 60a and 60b hold the sheet S in nips formed between the driving rollers and the driven rollers and convey the sheet S. The nips of the pair of cutting unit conveying rollers 60a and 60b are disposed in parallel to each other. Consequently, the sheet S is planarly held between the pair of cutting unit conveying rollers 60a and 60b. The pair of cutting unit conveying rollers 60a and 60b holds the sheet S planarly in the position of the rotary cutter 61 and conveys the sheet S. In the pair of cutting unit conveying rollers 60a and 60b, conveying speed of the sheet S is controlled by the control unit 37. The control unit 37 controls the conveying speed of the sheet S by the pair of cutting unit conveying rollers 60a and 60b to speed equal to or lower than upper limit speed at which the sheet S can be cut by the rotary cutter 61.

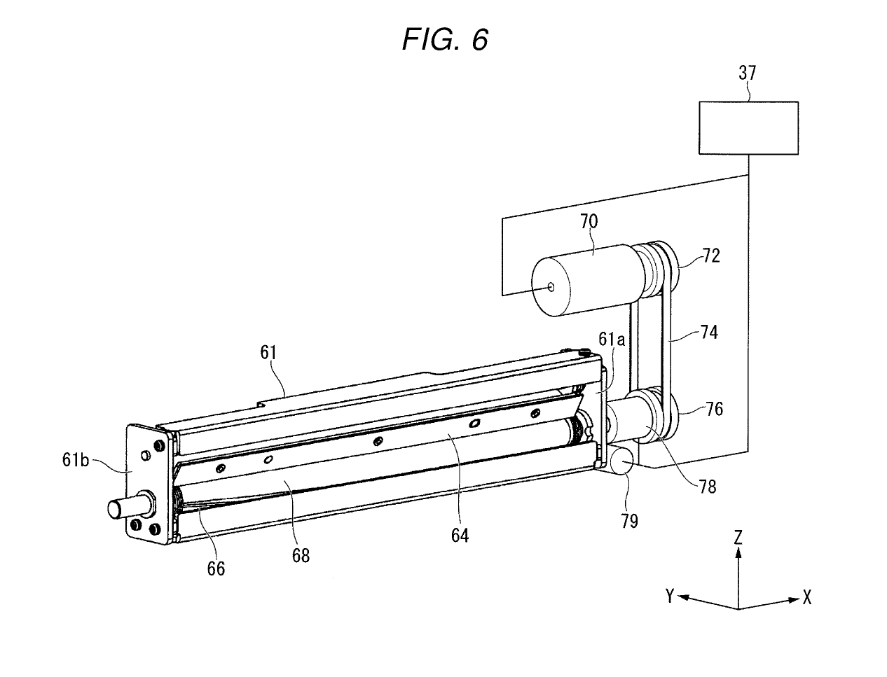

FIG. 6 is a perspective view of the rotary cutter. The rotary cutter 61 includes a fixed blade 64, a rotary blade 66, a motor 70, a clutch 78, and a solenoid 79.

The fixed blade 64 is formed in a rectangular plate shape. Both end portions in the longitudinal direction of the fixed blade 64 are fixed to a pair of frames 61a and 61b. The frames 61a and 61b are formed in a flat shape. The pair of frames 61a and 61b is disposed in parallel to each other.

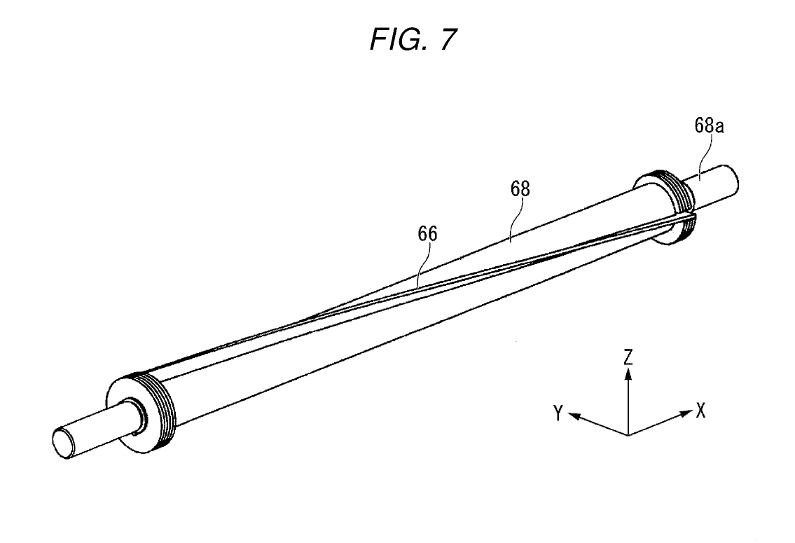

FIG. 7 is a perspective view of the rotary blade and a rotary-blade supporting member. The rotary blade 66 is supported by a rotary-blade supporting member 68. The rotary-blade supporting member 68 is formed in a columnar shape. The rotary blade 66 is disposed along the outer circumferential surface of the rotary-blade supporting member 68. The rotary blade 66 spirally extends from a first end portion to a second end portion in the axial direction of the rotary-blade supporting member 68. As shown in FIG. 6, the rotary-blade supporting member 68 is disposed between the pair of frames 61a and 61b. The rotary-blade supporting member 68 is rotatably supported by the pair of frames 61a and 61b. A rotary blade pulley 76 is attached to a rotating shaft 68a (see FIG. 7) of the rotary-blade supporting member 68.

The motor 70 is fixed to the first frame 61a of the pair of frames 61a and 61b. A motor pulley 72 is attached to a rotating shaft of the motor 70. A belt 74 is laid over between the motor pulley 72 and the rotary blade pulley 76. Consequently, it is possible to transmit torque from the motor 70 to the rotary blade 66. The operation of the motor 70 is controlled by the control unit 37. Consequently, the control unit 37 controls rotating speed of the rotary blade 66.

The clutch 78 is disposed in the rotating shaft 68a between the rotary blade pulley 76 and the rotary-blade supporting member 68. The clutch 78 connects and disconnects a torque transmission route extending between the rotary blade pulley 76 and the rotary-blade supporting member 68.

The solenoid 79 connects and disconnects the clutch 78. The operation of the solenoid 79 is controlled by the control unit 37.

The rotary cutter 61 cuts the sheet S as explained below. The sheet S is inserted through between the rotary-blade supporting member 68 and the fixed blade 64. The control unit 37 drives the motor 70 during the conveyance of the sheet S. The control unit 37 disconnects the clutch 78 via the solenoid 79 if the sheet S is not cut. Consequently, the rotary blade 66 does not rotate. The control unit 37 connects the clutch 78 via the solenoid 79 if the sheet S is cut. Consequently, the torque of the motor 70 is transmitted to the rotary-blade supporting member 68 and the rotary blade 66 rotates. The control unit 37 controls the rotating speed of the rotary blade 66 according to the conveying speed of the sheet S. The rotary blade 66 holds the sheet S between the rotary blade 66 and the fixed blade 64 and cuts the sheet S. Since the rotary blade 66 is formed in a spiral shape, the sheet S being conveyed is cut perpendicularly to the conveying direction. The pair of cutting unit conveying rollers 60a and 60b shown in FIG. 2 holds the sheet S planarly in the position of the rotary cutter 61 and conveys the sheet S. Consequently, the rotary cutter 61 linearly cuts the sheet S being conveyed.

The sheet discarding unit 80 stores an unnecessary sheet S cut by the cutting unit 60. The sheet discarding unit 80 is supported by the case 32. The sheet discarding unit 80 includes a paper discharge box 82 and a flapper 84.

The paper discharge box 82 is disposed below the conveying route of the sheet S. The upper surface of the paper discharge box 82 is opened. The flapper 84 can switch a posture between a first posture indicated by a solid line and a second posture indicated by a broken line in FIG. 2. The first posture is a posture for guiding the sheet S in the conveying direction. The second posture is a posture for guiding the sheet S in the direction of the paper discharge box 82. The operation of the flapper 84 is controlled by the control unit 37. The leading end of the sheet S let out from the roll paper 35 is cut by the cutting unit 60. The leading end of the sheet S that has caused a sheet jam is also cut by the cutting unit 60. In these cases, the sheet Son the downstream side of a cutting position is unnecessary. The control unit 37 switches the flapper 84 to the second posture and guides the sheet S on the downstream side in the direction of the paper discharge box 82. The sheet S on the downstream side is stored in the paper discharge box 82 and discarded. The sheet S on the upstream side of the cutting position is used for image formation. The control unit 37 switches the flapper 84 to the first posture and guides the sheet S on the upstream side in the conveying direction. The sheet S on the upstream side is fed to the image forming apparatus main body 1a.

The outlet unit 90 conveys the sheet S toward the outlet 38 for delivering the sheet S to the outside. The outlet unit 90 is supported by the case 32. The outlet unit 90 includes a plurality of outlet rollers (second conveying rollers) 93, 94, and 95. The plurality of outlet rollers 93, 94, and 95 include a third conveying roller 93, a fourth conveying roller 94, and a fifth conveying roller 95. The outlet rollers 93, 94, and 95 include driving rollers and driven rollers. The driving rollers and the driven rollers are disposed across the sheet S. The driving rollers are driven to rotate by the motor 36. The driven rollers rotate according to the rotation of the driving rollers. The conveying speed of the sheet S in the outlet unit 90 is controlled by the control unit 37. If the sheet S is cut by the cutting unit 60, the control unit 37 controls conveying speed V1 of the sheet S in the cutting unit 60 and the outlet unit 90 to speed equal to or lower than the upper limit speed at which the sheet S can be cut by the rotary cutter 61. Conveying speed V2 of the sheet S in the image forming apparatus main body 1a is sometimes higher than the conveying speed V1. The paper feeding device 30 passes the sheet S to the image forming apparatus main body 1a at the conveying speed V2 in the outlet 38. After the sheet S is cut by the cutting unit 60, the control unit 37 increases the conveying speed of the sheet S in the outlet unit 90 from V1 to V2. After the sheet S is cut by the cutting unit 60, the control unit 37 increases the conveying speed of the sheet S by the outlet rollers 93, 94, and 95. At this point, the conveying speed of the sheet S by the outlet rollers 93, 94, and 95 is higher than the conveying speed of the sheet S by the cutting unit conveying rollers 60a and 60b.

The paper feeding device 30 in the embodiment includes the cassette 34, the curl rectifying unit 50, and the cutting unit 60. The cassette 34 is capable of storing the roll paper 35. The curl rectifying unit 50 is disposed on the downstream side of the roll paper 35 in the conveying direction of the sheet S let out from the roll paper 35 and rectifies a curl of the sheet S. The cutting unit 60 is disposed on the downstream side of the curl rectifying unit 50 in the conveying direction and cuts the sheet S. Since the paper feeding device 30 includes the cutting unit 60 that cuts the sheet S let out from the roll paper 35, the paper feeding device 30 can feed the sheet S of any size to the image forming apparatus main body 1a. Since the paper feeding device 30 includes the curl rectifying unit 50 disposed on the upstream side of the cutting unit 60, the paper feeding device 30 can feed the sheet S, the curl of which is rectified, to the cutting unit 60. Consequently, the paper feeding device 30 can prevent a sheet jam in the cutting unit 60.

Since the paper feeding device 30 includes the glue removing unit 44 that removes the adhesive glue oozing from the label adhering to the sheet S, the paper feeding device 30 prevents the adhesive glue from adhering to the downstream side of the glue removing unit 44. The glue removing unit 44 is disposed on the upstream side of the curl rectifying unit in the conveying direction. Consequently, the paper feeding device 30 can prevent the adhesive glue from adhering to the curl rectifying unit 50.

The cutting unit 60 includes the rotary cutter 61 that cuts the sheet S being conveyed. Consequently, since the paper feeding device 30 does not stop the conveyance of the sheet S to cut the sheet S, the paper feeding device 30 can increase paper feeding speed. The cutting unit 60 includes the cutting unit conveying rollers 60a and 60b respectively disposed on the upstream side and the downstream side of the rotary cutter 61 in the conveying direction. By disposing the cutting unit conveying rollers 60a and 60b in the front and the back of the rotary cutter 61, it is possible to prevent positional deviation during the cutting of the sheet S. The cutting unit conveying rollers 60a and 60b hold the sheet S planarly in the position of the rotary cutter 61 and conveys the sheet S. Consequently, the rotary cutter 61 can linearly cut the sheet S. Therefore, the paper feeding device 30 can feed a high-quality sheet cut in a predetermined shape.

The rotary cutter 61 includes the fixed blade 64, the rotary blade 66, the motor 70, and the clutch 78. The motor 70 rotates the rotary blade 66. The clutch 78 connects and disconnects the torque transmission route extending from the motor 70 to the rotary blade 66. Consequently, the rotary cutter 61 can cut the sheet S in any position.

The paper feeding device 30 includes the outlet rollers 93, 94, and 95 disposed on the downstream side of the cutting unit 60 in the conveying direction. The outlet rollers 93, 94, and 95 convey the sheet S toward the outlet 38 for delivering the sheet S to the outside. After the sheet S is cut by the cutting unit 60, the control unit 37 increases the conveying speed of the sheet S by the outlet rollers 93, 94, and 95. At this point, the outlet rollers 93, 94, and 95 convey the sheet S at the conveying speed higher than the conveying speed of the sheet S by the cutting unit conveying rollers 60a and 60b. Consequently, the paper feeding device 30 can feed the sheet S from the outlet 38 to the image forming apparatus main body 1a according to the conveying speed of the sheet S in the image forming apparatus main body 1a.

The paper feeding device 30 includes the paper discharge box 82 disposed on the downstream side of the cutting unit 60 in the conveying direction. The paper discharge box 82 stores the unnecessary sheet S cut by the cutting unit 60. The paper feeding device 30 includes the flapper 84 disposed on the downstream side of the cutting unit 60 in the conveying direction. The flapper 84 is capable of switching the posture between the first posture for guiding the sheet S in the conveying direction and the second posture for guiding the sheet S in the direction of the paper discharge box 82. Consequently, the paper feeding device 30 can collect the unnecessary sheet S.

The cassette 34 that stores the roll paper 35 is disposed at the second end portion on the opposite side of the first end portion where the outlet 38 for delivering the sheet S to the outside is formed. Consequently, since the distance from the roll paper 35 to the outlet 38 is secured, flexibility of layout of the paper feeding device 30 is improved. In particular, since the distance from the cutting unit 60 to the outlet 38 is secured, it is possible to sufficiently accelerate the sheet S with the outlet rollers 93, 94, and 95.

The image forming apparatus 1 in the embodiment includes the paper feeding device 30 and the image forming apparatus main body 1a. The image forming apparatus main body 1a forms an image on the sheet S fed from the paper feeding device 30. Consequently, the image forming apparatus 1 can form an image on the sheet S of any size. The image forming apparatus 1 feeds the sheet S to the image forming apparatus main body 1a after cutting the sheet S in the paper feeding device 30. Consequently, the image forming apparatus 1 can prevent the sheet S further on the upstream side than the cutting position from remaining in the image forming apparatus main body 1a. Therefore, the image forming apparatus 1 can prevent the sheet S from being left untouched in a state in which the sheet S is in contact with the intermediate transfer body 27 and the fixing device 28.

The paper feeding device 30 in the embodiment is configured to drive to rotate the rollers with the motor 36. On the other hand, the rollers may be respectively driven to rotate by separate motors.

The configuration of the image forming apparatus main body 1a in the embodiment is an example. Other configurations may be adopted.

According to at least one embodiment explained above, since the paper feeding device 30 includes the cutting unit 60 that cuts the sheet S let out from the roll paper 35, the paper feeding device 30 can feed the sheet S of any size to the image forming apparatus main body 1a. Since the paper feeding device 30 includes the curl rectifying unit 50 disposed on the upstream side of the cutting unit 60, the paper feeding device 30 can prevent a sheet jam in the conveying route of the sheet S.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A paper feeding device comprising:
a roll-paper storing unit capable of storing roll paper;
a curl rectifying unit disposed on a downstream side of the roll-paper storing unit in a conveying direction of a sheet let out from the roll paper and configured to rectify a curl of the sheet; and
a cutting unit disposed on the downstream side of the curl rectifying unit in the conveying direction and configured to cut the sheet.

2. The device according to claim 1, further comprising a glue removing unit disposed on an upstream side of the curl rectifying unit in the conveying direction and configured to remove adhesive glue oozing from a label adhering to the sheet.

3. The device according to claim 1, wherein the cutting unit includes:
a rotary cutter configured to cut the sheet being conveyed; and
first conveying rollers respectively disposed on an upstream side and the downstream side of the rotary cutter in the conveying direction and configured to hold the sheet planarly in a position of the rotary cutter and convey the sheet.

4. The device according to claim 3, wherein the rotary cutter includes:
a fixed blade;
a rotary blade;
a motor configured to rotate the rotary blade; and
a clutch configured to connect and disconnect a torque transmission route extending from the motor to the rotary blade.

5. The device according to claim 3, further comprising second conveying rollers disposed on the downstream side of the cutting unit in the conveying direction and configured to convey, toward an outlet for delivering the sheet to an outside, the sheet at conveying speed higher than or same as conveying speed of the sheet by the first conveying rollers.

6. The device according to claim 3, further comprising:
second conveying rollers disposed on the downstream side of the cutting unit in the conveying direction and configured to convey the sheet toward an outlet for delivering the sheet to an outside; and
a control unit capable of increasing conveying speed of the sheet by the second conveying rollers after the sheet is cut by the cutting unit.

7. The device according to claim 1, further comprising a paper discharge box disposed on the downstream side of the cutting unit in the conveying direction and configured to store an unnecessary sheet cut by the cutting unit.

8. The device according to claim 7, further comprising a flapper disposed on the downstream side of the cutting unit in the conveying direction and capable of switching a posture between a first posture for guiding the sheet in the conveying direction and a second posture for guiding the sheet in a direction of the paper discharge box.

9. The device according to claim 1, wherein the roll-paper storing unit is disposed at a second end portion on an opposite side of a first end portion where an outlet for delivering the sheet to an outside is formed.

10. An image forming apparatus comprising:
the paper feeding device according to claim 1; and
an image forming apparatus main body configured to form an image on the sheet fed from the paper feeding device.
